(19) United States
(12) Patent Application Publication
(10) Pub. No.: US 2015/0352808 A1
(43) Pub. Date: Dec. 10, 2015

(54) FURNITURE PANEL

(71) Applicant: THE TOP EDGE LIMITED, South Yorkshire (GB)

(72) Inventor: Jonathan Rusby, Sheffield South Yorkshire (GB)

(21) Appl. No.: 14/761,762

(22) PCT Filed: Jan. 16, 2014
(86) PCT No.: PCT/GB14/50113

§ 371 Date: Jul. 17, 2015

(30) Foreign Application Priority Data
Jan. 17, 2013 (GB) 1300836.2

(51) Int. Cl. B32B 5/18; B32B 29/00; B29C 65/48; B32B 37/18; B29C 65/00; B32B 27/06; B32B 37/12

(52) U.S. Cl. CPC B32B 5/18; B32B 27/065; B32B 29/007; B32B 37/12; B32B 37/182; B29C 66/45; B29C 66/73771; B29C 66/7352; B29C 65/48; B32B 2260/028; B32B 2260/046; B32B 2266/0264; B32B 2307/558; B32B 2307/7265; B32B 2479/00; B32B 2325/00; B32B 2317/16; B32B 2317/12; B29K 2625/06; B29K 2711/14

(57) ABSTRACT

The present invention relates to a furniture panel comprising a polymeric foam core sandwiched between a top and bottom layer, a method of making the furniture panel and use of polymeric foam in the manufacture of furniture panels.

### RELATED APPLICATIONS AND CLAIM OF PRIORITY

This patent document claims priority to International Patent Application No. PCT/GB2014/050113, filed Jan. 16, 2014, which in turn claims priority to United Kingdom Patent Application No. 1300836.2, filed Jan. 17, 2013. The disclosure of each priority application is hereby incorporated by reference.

### BACKGROUND

This invention relates to furniture panels, preferably lightweight furniture panels, and methods for making them.

Wood particleboards with varying particle sizes serve as starting materials for furniture construction. Such particleboards are usually pressed with binders along with other additives to give a finished product. The industrial demands for wood materials are very high, particularly in furniture and building applications. However, such wooden boards have a number of disadvantages. For example, they may be prone to swelling when in contact with water, and they may be heavy to handle, use and install.

In order to avoid disadvantageous water swelling behaviour, wooden particleboard can be treated with water proofing agents in the production process and further enhanced using suitable binders. However, even following such procedures, the water resistance of wooden particleboard is not at a commercially desirable level.

Furthermore, the weight of existing wooden particleboards is a major drawback. There is an increasing need for light weight boards particularly due to at least the following:
Increasing oil price which leads to continual increase in transport cost. The boards are forwarded from manufacturers to fabricators and retailers whose facilities may be thousands of miles away. Trucks transporting these boards are not always full: their load limit is reached before their loading space is completely full.
Easy installation: The heaviness of the existing board often necessitates 2-3 fitters/carpenters to install. Particularly, installation becomes complex in multi-story buildings.

Some lighter than standard weight particle boards exist. For example:

EP 2 147 778 discloses a furniture panel with a core of comprising a cellulosic material, in particular a paper or cardboard in a honeycomb structure.

EP 2 487 016 discloses a wooden product made of three dimensional arrangements of two different densities in the wooden panel. In comparison to the standard technologies, where surface results in the higher density areas, this novel process has higher density in the core in a specific wave pattern.

However, a common disadvantage with such particleboards is that they are not water resistant and may be prone to water absorption or water swelling.

Clearly, there is a commercial need for a lightweight and more water resistant furniture panel. Furthermore, there also exists a need for a furniture panel having a higher drop impact strength.

### SUMMARY

The present invention relates to a furniture panel comprising a polymeric foam core sandwiched between a top and bottom layer.

Suitably, the thickness of either the top layer alone or where the supporting layer is present, the combined thickness of the top layer and supporting layer is at least 1.5 mm.

Suitably, the density of the foam may vary from approx 10 kg/m³ to approximately 200 kg/m³, such as from approx 20 kg/m³ to approximately 200 kg/m³. Preferably, the density of the foam is 10-50 kg/m³, such as from 30-50 kg/m³.

Suitably, the polymeric foam comprises at least one polymeric material selected from the group consisting of: polystyrene, polyethylene, polyurethane, phenolic, melamine, PVC, PET, polypropylene, and polyisocyanurate. In one embodiment, the polymeric material is polystyrene foam.

Suitably the top layer and/or bottom layer may be formed using a laminated material, such as high pressure laminate.

Suitably, the furniture panel may comprise a supporting layer between the top layer and the polymeric foam core. The supporting layer may be made of any material which may reinforce the furniture panel, such as compacted phenolic and/or melamine resin impregnated Kraft paper (e.g. compact grade or solid grade laminate); a thermoplastic sheet (such as ABS, HDPE, LDPE, Nylon, PP or Acrylic); a thermoset polymeric sheet or combinations thereof.

Suitably, the top layer is at least 0.5 mm in thickness. Where a supporting layer is present, suitably the supporting layer is at a thickness of at least 1 mm Suitably the thickness of the one or more layers on top of the polymeric foam core (e.g. the top layer alone or the top layer and supporting layer combined) has a thickness of at least 1.5 mm, preferably at least 2 to 4 mm.

Suitably, the bottom layer may have a thickness of at least 0.1 mm or at least 0.5 mm Preferably, the bottom layer has a thickness in the range of 0.5 mm to 4 mm.

Suitably, the furniture panel may also comprise one or more rigid solid inserts which may be glued in to provide improved fastening with other furniture panels or components/surfaces. Said or more rigid solid insert solid inserts may be casted thermoplastic or thermosetting plastic.

The present invention further provides a method of producing a furniture panel in accordance with the present invention, said method comprising;

4) Providing a bottom layer;

5) Affixing a polymeric foam to the bottom layer;

6) Affixing a top layer on top.

Suitably, a supporting layer as defined herein may also be affixed on top of the polymeric foam and the top layer is affixed on top of the supporting layer.

Suitably, the layers may be affixed to one another using adhesive, such as polyurethane, epoxy glue, ethyl vinyl acetate, polyvinyl acetate and neoprene.

The present invention also relates to the use of polymeric foam in the manufacture of a furniture panel. Suitably the polymeric foam may form the core of the furniture panel.

### BRIEF DESCRIPTION OF THE FIGURES

FIG. 1 shows the cross-section of a furniture panel in accordance with the present invention.

### DETAILED DESCRIPTION

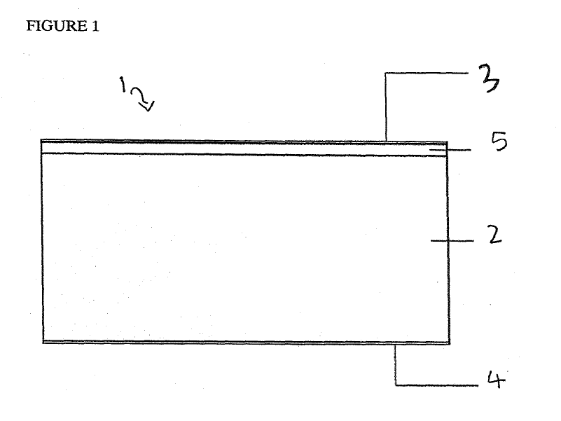

Referring to FIG. 1 which shows a specific embodiment of a furniture panel 1 comprising a polymeric foam core 2 sandwiched between a top layer 3 and a bottom layer 4. This furniture panel 1 also has a supporting layer 5 between the top layer 3 and the polymeric foam core 2.

Any polymeric foam may be used as the core 2. Examples of suitable polymeric foam core materials include: polystyrene, polyethylene, polyurethane, phenolic, melamine, PVC, PET, polypropylene, and polyisocyanurate. However, any other polymeric foam may be used. Advantageously, polymeric foam is both lightweight and has good water resistance. Thus, furniture panels using polymeric foam as the core of the panel will be lighter and more resistant to water absorption compared with conventional wooden particleboards. Furthermore, this allows the furniture panel of the present invention to be easier to handle, less prone to water swelling and may provide cost-efficiencies. Additionally, by being resistant to water absorption, the furniture panel of the present invention may have enhanced lifespan over conventional particleboards in water environments (e.g. kitchens and bathrooms).

Suitably, the polymeric foam core 2 may be an open cell or a closed cell polymeric foam material. Both open cell and closed cell foams resist water swelling. Suitably, closed cell polymeric foam may be used; this may desirably provide more rigidity than open cell polymeric foam.

Preferably, the polymeric foam core 2 comprises polystyrene. The thickness of the polymeric foam core 2 will depend on the desired thickness of the furniture panel. For example, a thickness in the range of 9 mm to 100 mm may typically be used.

The bottom layer 4 of the furniture panel 1, may be made of any suitable material which may protect the polymeric foam core 2. Examples include compacted phenolic and/or melamine resin impregnated Kraft paper (e.g. compact grade or solid grade laminate); high pressure laminate; a thermoplastic sheet (such as ABS, HDPE, LDPE, Nylon, PP or Acrylic); a thermoset polymeric sheet or combinations thereof. Preferably, the bottom layer comprises high pressure laminate.

The thickness in cross-section of the bottom layer may be greater than 0.01 mm, preferably greater than 0.1 mm, preferably greater than 0.5 mm Suitably, the thickness in cross-section of the bottom layer may be in the range of 0.1 mm to 4 mm, preferably 0.5 mm to 4 mm Preferably, the bottom layer may be approximately 0.73 mm.

The top layer 3 of the furniture panel 1 may be made of any suitable material which may protect the polymeric foam core 2. Preferably, the material used for the top layer 3 is a material which has sufficient impact resistance, dry heat resistance, wet heat resistance, resistance to marking by liquids (e.g. acetone, ethanol, tea, coffee, disinfectant, Paraffin oil, blackcurrant juice, ammonia, acetic acid and/or olive oil), resistance to marking by cold oils and fats (e.g. solid vegetable oil and/or vegetable fat, and/or water resistance to be used as a kitchen work surface. Suitably, the top layer may be comprised of a material typically used for kitchen work surfaces. In one preferable aspect the top layer is high pressure laminate.

The optimal thickness of the top layer 3 may be dependent in part on the presence or absence of a supporting layer 5. Suitably the top layer 3 has a thickness of at least 0.2 mm, preferably at least 0.5 mm even if a supporting layer 5 is present. When a supporting layer is present, suitably the thickness of the top layer 3 may be approximately 0.5 mm to approximately 1.2 mm. When no supporting layer 5 is present, then the top layer may be thicker, such as at least 2 mm, or at least 3 mm or at least 4 mm or at least 5 mm.

The thickness of the top layer and/or the combined thickness of the top layer and supporting will vary depending according to the impact strength of the materials used. For example where glass fibre is used the combined thickness of the top layer and supporting layer (if present) may be lower than that used for high pressure laminate. For example a combined thickness under 1 mm may be suitable.

Accordingly, the ranges for provided for the thicknesses of the top layer, supporting layer, bottom layer and combinations thereof may in one aspect be used as reference for the range of impact strength when using high pressure laminate. A skilled person can readily compare the difference in impact strength between high pressure laminate and other materials and adjust the ranges accordingly. Thus, in one aspect, thickness ranges of other materials providing the same impact strength as the disclosed ranges for high pressure laminate are encompassed by the present invention.

The supporting layer 5 is optional. The use of a supporting layer 5 is advantageous as it may allow the top layer 3 to be of a standard thickness used for conventional particleboards. Thus, the range of, for example, high pressure laminate surface finishes can be applied to the furniture panel of the present invention.

When present, the supporting layer 5 is sandwiched between the top layer and the polymeric foam core. The supporting layer may be made of any material which may reinforce the furniture panel, such as compacted phenolic and/or melamine resin impregnated Kraft paper (e.g. compact grade or solid grade laminate); a thermoplastic sheet (such as ABS, HDPE, LDPE, Nylon, PP or Acrylic); a thermoset polymeric sheet (with or without fillers) or combinations thereof. Preferably, the supporting layer comprises compacted phenolic and/or melamine resin impregnated Kraft paper (e.g. compact grade or solid grade laminate).

In one embodiment of the present invention, the furniture panel may have a supporting layer between the bottom layer and the polymeric foam core. This may be in addition to or an alternative to the support layer 5 between the top layer and the polymeric foam core.

The supporting layer between the bottom layer and the polymeric foam core may have one or more of the properties of the support layer 5. Thus, features disclosed for the support layer 5 may also be features of the supporting layer between the bottom layer and the polymeric foam core.

The addition of a supporting layer between the bottom layer and the polymeric foam core may advantageously provide an enhanced fastening system, improved handling and/or improved manufacturability etc.

Suitably, the furniture panel may also comprise one or more rigid solid inserts which may be glued in to provide improved fastening with other furniture panels or components/surfaces. Said or more rigid solid inserts may be casted thermoplastic or thermosetting plastic.

Suitably, the furniture panel of the present invention may fulfil the technical requirements given in BS 6222 and BS EN 14749 for kitchen work surfaces. These requirements are detailed in Table 1.

The furniture panel of the present invention may be made by affixing the bottom layer 4 to the polymeric foam core 3. This may be achieved using a moisture resistant adhesive such as polyurethane, epoxy glue, ethyl vinyl acetate, polyvinyl acetate and neoprene.

When a supporting layer 5 is used this is affixed to the upper surface of the polymeric foam core 2 and the top layer 3 is affixed onto the upper surface of the supporting layer. The means of affixing the layers together may be any suitable means such as the use of moisture resistant adhesive such as polyurethane, epoxy glue, ethyl vinyl acetate, polyvinyl acetate and neoprene.

Advantageously, the lightweight and water resistant furniture panel of the present invention may be produced using convention techniques for chipboard in terms of the application of adhesive, CNC machines and edge banding machines. Advantageously, this enables a furniture panel to be produced with edge strips, thereby increasing the decorative appearance and allowing the edge strips to match the surface. Furthermore, the presence of edge strips provides enhanced edge protection.

Therefore, the furniture panels of the present invention may comprise edge strips. Suitably, the edge strips may match the appearance of the top surface of the panel. Furthermore, the methods of the present invention may include the further step of applying edging strips.

Furthermore, advantageously, the lightweight and water resistant furniture panel of the present invention may have increased drop impact strength.

The furniture panels of the present invention may have utility in a wide range of furniture applications such as in the production of office furniture, bedroom furniture, bathroom furniture and the like. Suitably, the furniture panel of the present invention may have particular utility as a kitchen worktop surface.

### EXAMPLES

### Methodology

TABLE 1

| Properties | Methodology | Requirement |
|---|---|---|
| Large ball Impact | BS 6222-3 | Indentation less than or equal 10 |
| resistance | | mm diameter |
| Dry heat resistance | BS 6222-3/BS | Rating 5, 4, 3 at 120, 140, 160° C. |
| | EN 12722 | |
| Wet heat resistance | BS 6222-3/BS | Rating 5, 4, 4 at 55, 70, 85° C. |
| | EN12721 | |
| Resistance to marking | BS 6222-3/BS | Rating 5 |
| by liquids (acetone, | EN 12720 | |
| ethanol, tea, coffee, | | |
| disinfectant, paraffin | | |
| oil, black current juice, | | |
| ammonia, acetic acid, | | |
| olive oil) | | |
| Resistance to marking | BS 6222-3/BS | Rating 5 |
| by cold oils and | EN 12720 | |
| fats(Solid vegetable oil | | |
| and solid vegetable fat) | | |
| Vertical fatigue test on | BS 6222-2 | Fatigue test with load 300N for |
| worktops and breakfast | | 30,000 cycles. |
| bars | | None of the following should |
| | | occur as a part of requirement: |
| | | any fracture of any member, joint |
| | | or component; |
| | | any loosening, shown to be |
| | | permanent by hand pressure to |
| | | suitable members, of joints |
| | | intended to be rigid; |
| | | any loosening of any means of |
| | | fixing components to the article; |
| | | any deflection of worktop greater |
| | | than span/200 for particle board, |
| | | span/150 for wood or span/100 |
| | | for other materials |
| | | More information can be found in |
| | | clause 4.1 BS 6222-2:2009 |
| Kitchen worktop— | BS EN 14749 | Fatigue test with load 1000N for |
| safety requirement test | | 10 cycles. After the test the |
| | | worktop surface and/or unit shall |
| | | show no fracture or other damage |
| | | that can affect the safety. More |
| | | information can be found in BS |
| | | EN 14749. |
| Water absorption test | Modified BS | For comparison purpose. |
| or determination of | EN 317 | |
| swelling in thickness | (Internal Test | |
| after immersion in | Method) | |
| water | | |
| Degree of weight | Internal test | For comparison purpose. |
| reduction | method | |
| Adhesion test of | BS 6222-3 | Rating 4 for surfaces at 40, 50, 60, |
| surface | | 70° C. |
| Adhesion test of edging | BS 6222-3 | Rating 4, 4, 3 at 40, 50 and 60° C. |

Determination of Swelling in Thickness after Immersion in Water

This is a test to measure the water absorption behaviour. The method mentioned in BS EN 317 will be conducted with the following minor change. Board with high pressure laminate surface and without edge protection will be used for testing purpose. The test pieces were immersed in water for 24 hrs and thickness is measured before and after immersion.

% Swelling=(thickness after immersion−thickness before immersion/thickness before immersion)×100

Determination of Degree of Weight Reduction

This is for comparison purpose with conventional chipboard. The degree of weight reduction is calculated as a percentage of the weight of a standard kitchen worktop (Chipboard reference sample) of similar size and thickness.

Chipboard Reference Sample Specification:
Thickness of surface high pressure laminate is 0.8 mm±0.1 mm as upper layer and thickness of backing paper (Kraft paper of 88 gsm) as lower layer.
Total thickness of the particle board work surface with high pressure laminate and backing paper is between 9 mm to 100 mm.

Test Sample Specification:
Thickness of surface high pressure laminate is 0.8±0.1 mm as upper layer and conventional backing laminate of thickness between 0.5 mm to 0.8 mm as lower layer.
Total thickness of the foam sandwich panel ranges from 10 mm to 100 mm with supporting layer thickness between 1 mm to 5 mm and foam layer thickness between 9 mm to 95 mm.

### Example 1

The furniture panel of construction shown in FIG. 1 was made with a top layer and a bottom layer of 0.8 mm high pressure laminate, 3 mm supporting layer (compact grade solid laminate) and 35 mm polystyrene foam glued together with polyurethane adhesive. The above mentioned tests were conducted and reported in table 2.

### Example 2

The furniture panel of construction shown in FIG. 1 was made with a top layer and a bottom layer of 0.8 mm high pressure laminate, 2 mm supporting layer (compact grade solid laminate) and 35 mm polystyrene foam glued together with polyurethane adhesive. The above mentioned tests were conducted and reported in table 2.

### Example 3

A furniture panel was made of 0.8 mm thick high pressure laminate, 38 mm thick chipboard and conventional backing paper. This has been made to resemble traditional chipboard based worktop

### Example 4

A furniture panel was made of paper honeycomb with MDF/chipboard as surface layers with high pressure laminate on top surface. The total thickness of the panel is 38 mm with 8 mm MDF/chipboard surface layers on both the sides.

Results

The furniture panels of Examples 1 to 4 have traditional high pressure laminate surface which meets some of the surface requirements mentioned in BS EN 438, BS EN 12720, BS EN 12721 and BS 6222-3. Hence the tests mentioned in BS EN 12720 and BS EN 12721 do not need to be conducted.

TABLE 2
Test results

| | | | | Example 4 |
|---|---|---|---|---|
| | | | Example 3 | Paper |
| | | | Chipboard | Honeycomb |
| Properties | Example 1 | Example 2 | worktop | worktop |
| Impact test | Pass | Pass | Pass | Pass |
| Heat test | Pass | Pass | NA | NA |
| Adhesion test | Pass | Pass | NA | NA |
| Vertical fatigue | Pass | Pass | NA | NA |
| test | | | | |
| Kitchen | Pass | Pass | NA | NA |
| worktop—safety | | | | |
| requirement test | | | | |
| % Swelling | 0.22 | 0.25 | 12.1 | Not Tested |
| after immersion | | | | |
| in water | | | | |
| Weight as % | 33 | 25 | 100 | 56** |
| of control | | | | |
| Example 3 | | | | |
| Density kg/m³ | 183.97 | 147.11 | 583.8 | 325¹ |

*NA—Not available
**—Estimated from density
¹Estimated from manufacturers brochure: Egger Eurolight Board (Page 55)

1. A kitchen worktop comprising a polymeric foam core sandwiched between a top and bottom layer and a supporting layer between the top layer and the polymeric foam core, wherein the polymeric foam core comprises PET, wherein the worktop comprises edge strips and wherein the density of the foam varies from approximately 10 kg/m³ to approximately 200 kg/m³.

2. The kitchen worktop according to claim 1 wherein the thickness of either the top layer alone or the top layer combined with the supporting layer is at least 1.5 mm.

3. (canceled)

4. (canceled)

5. The kitchen worktop according to claim 1, wherein one or more of the top layer and the bottom layer is formed using a laminated material.

6. The kitchen worktop according to claim 5, wherein the laminated material is high pressure laminate.

7. (canceled)

8. The kitchen worktop according to claim 1 wherein the supporting layer comprises one or more of the following materials: compacted phenolic, melamine resin impregnated Kraft paper, a thermoplastic sheet, and a thermoset polymeric sheet.

9. (canceled)

10. The kitchen worktop according to claim 1 wherein the top layer is at least 1 mm in thickness.

11. The kitchen worktop according to claim 1 wherein the top layer is at a thickness of at least 0.2 mm.

12. The kitchen worktop according to claim 1 wherein the supporting layer is at a thickness of at least 0.2 mm.

13. The kitchen worktop according to claim 1 wherein the bottom layer has a thickness of at least 0.5 mm.

14. The kitchen worktop according to claim 13 wherein the bottom layer has a thickness in the range of 0.5 mm to 4 mm.

15. (canceled)

16. A method of producing a kitchen worktop, said method comprising;
providing a bottom layer;
affixing a polymeric foam to the bottom layer; and
affixing a top layer on top.

17. The method according to claim 16, wherein a supporting layer is affixed on top of the polymeric foam and the top layer is affixed on top of the supporting layer.

18. The method according to claim 17, wherein the top layer is approximately 3 mm.

19. The method according to claim 16 wherein the layers are affixed to one another using adhesive.

20. The method according to claim 19 wherein the adhesive is one or more of the following: polyurethane, epoxy glue, ethyl vinyl acetate, polyvinyl acetate and neoprene.

21. (canceled)

22. (canceled)

23. (canceled)

24. (canceled)

25. The kitchen worktop according to claim 1 wherein the PET foam core comprises a closed cell structure.
